(19) United States
(12) Patent Application Publication
(10) Pub. No.: US 2016/0283989 A1
(43) Pub. Date: Sep. 29, 2016

(54) LOCATION-ENABLED VISITOR MESSAGING AND FEEDBACK SOLUTIONS

(71) Applicant: NCR Corporation, Duluth, GA (US)

(72) Inventor: Virgilio Ayuban Esquilla, JR., Bohol (PH)

(21) Appl. No.: 14/667,978

(22) Filed: Mar. 25, 2015

(51) Int. Cl. G06Q 30/02; H04L 12/58; H04W 4/02

(52) U.S. Cl. CPC G06Q 30/0281; H04W 4/021; H04L 51/20

(57) ABSTRACT

Various embodiments each include at least one of systems, methods, and software for location-enabled visitor messaging, such as messaging customers upon departure from a facility to provide them with one or more of a summary of a transaction, promotional information, a link to connect with a facility employee, and a survey about their visit. One such embodiment includes receiving a data item unique to a customer account and a location identifier and determining whether the customer account is associated, in stored data, with a facility associated with the location identifier. When the customer account is associated with the facility, such embodiments then disassociate the customer account from the facility in the stored data and transmit a message to a network destination defined within customer account data.

### BACKGROUND INFORMATION

Customers visit facilities, such as retail outlets, for various purposes, such as to make a purchase, research products, and obtain service, among others. Facility operators typically do not know the purpose for a customer visit and therefore typically do not know whether a visiting customer is satisfied upon departure. Further, whether customers leave a satisfied or dissatisfied sentiment, the reasoning for this sentiment is unknown, yet this knowledge can provide great insight into facility modifications that may be made to improve future visits.

### SUMMARY

Various embodiments each include at least one of systems, methods, and software for location-enabled visitor messaging, such as messaging customers upon departure from a facility to provide them with one or more of a summary of a transaction, promotional information, and a survey about their visit.

One such embodiment includes receiving a data item unique to a customer account and a location identifier and determining whether the customer account is associated, in stored data, with a facility associated with the location identifier. When the customer account is associated with the facility, such embodiments then disassociate the customer account from the facility in the stored data and transmit a message to a network destination defined within customer account data.

### BRIEF DESCRIPTION OF THE DRAWINGS

FIG. 1 is a logical block diagram of a system, according to an example embodiment.

FIG. 2 is a logical block diagram of a system, according to an example embodiment.

FIG. 3 is a logical block diagram of a method, according to an example embodiment.

FIG. 4 is a logical block diagram of a method, according to an example embodiment.

FIG. 5 is a block diagram of a computing device, according to an example embodiment.

### DETAILED DESCRIPTION

Various embodiments each include at least one of systems, methods, and software for location-enabled visitor messaging, such as messaging customers upon departure from a facility to provide them with one or more of a summary of a transaction, promotional information, and a survey about their visit. This messaging of customers may be provided via text message to a customer mobile device, email, in-app messaging within an app that executes on a customer mobile device, and the like. In some embodiments, a message may be tailored to one or more of the specific customer, products and services viewed or purchased by the customer during a facility visit, the specific facility, and the operator of the facility, such as when the facility is one of many retail outlets of an entity that operates many of such outlets.

In some such embodiments, a customer may establish a customer account with an operator of a facility. The customer may also install an app on a mobile device to view and manipulate the customer account data, view products, shop, and the like. The facility may associated with location data in a backend system such that when a customer having a customer account is carrying their mobile device when they arrive at the facility, the facility, or the backend system, becomes aware of the customer's presence. The customer's presence may be determined in different ways in various embodiments. For example, the customer's presence may be determined from GPS coordinates sensed by a GPS device present in the mobile device, receipt by a radio transceiver device of the mobile device of a WI-FI® signal from a wireless access point or beacon identifier from a radio beacon device (e.g., a BLUETOOTH® beacon device) at a particular facility, receipt of location input by a customer, and the like. The customer may then visit different areas of the facility, which may be identified by similar mechanism as the customer's presence, and may complete one or more transactions. The transactions may be associated with the customer account, such as by the customer providing customer account identifying data at the time of conducting the transaction. Similarly, when the customer departs, this may also be determined in a similar manner. Upon detecting the departure of the customer, a message may be generated and sent to the customer. The message may simply be a thank you for visiting the facility. In some embodiments, the message may be a survey, or a link to a survey, the customer is asked to complete. The message may also, or alternatively, include content that is tailored to the particular customer based on transactions conducted during one or both of this and previous visits, products purchased or viewed, a customer account loyalty rewards-type balance, and the like. The goal of some such embodiments is to increase customer satisfaction at the end of their visit or to obtain customer feedback to make improvements to help the facility be successful.

In some further embodiments, additional messages may be sent to customers. Some such embodiments include a welcome message sent upon determining the presence of a customer. Other messages can be sent upon a customer visit to a certain area of the facility, upon viewing a particular product or interacting with a certain facility employee or member of a group of employees, and the like. Thus, while some embodiments may be tailored to providing customer messages upon departure, the platform systems of various embodiments may be leveraged for initiating additional customer interaction, promotion, feedback, and the like.

These and other embodiments are described herein with reference to the drawings.

In the following detailed description, reference is made to the accompanying drawings that form a part hereof, and in which is shown by way of illustration specific embodiments in which the inventive subject matter may be practiced. These embodiments are described in sufficient detail to enable those skilled in the art to practice them, and it is to be understood that other embodiments may be utilized and that structural, logical, and electrical changes may be made without departing from the scope of the inventive subject matter. Such embodiments of the inventive subject matter may be referred to, individually and/or collectively, herein by the term “invention” merely for convenience and without intending to voluntarily limit the scope of this application to any single invention or inventive concept if more than one is in fact disclosed.

The following description is, therefore, not to be taken in a limited sense, and the scope of the inventive subject matter is defined by the appended claims.

The functions or algorithms described herein are implemented in hardware, software or a combination of software and hardware in one embodiment. The software comprises computer executable instructions stored on computer readable media such as memory or other type of storage devices. Further, described functions may correspond to modules, which may be software, hardware, firmware, or any combination thereof. Multiple functions are performed in one or more modules as desired, and the embodiments described are merely examples. The software is executed on a digital signal processor, ASIC, microprocessor, or other type of processor operating on a system, such as a personal computer, server, a router, or other device capable of processing data including network interconnection devices.

Some embodiments implement the functions in two or more specific interconnected hardware modules or devices with related control and data signals communicated between and through the modules, or as portions of an application-specific integrated circuit. Thus, the exemplary process flow is applicable to software, firmware, and hardware implementations.

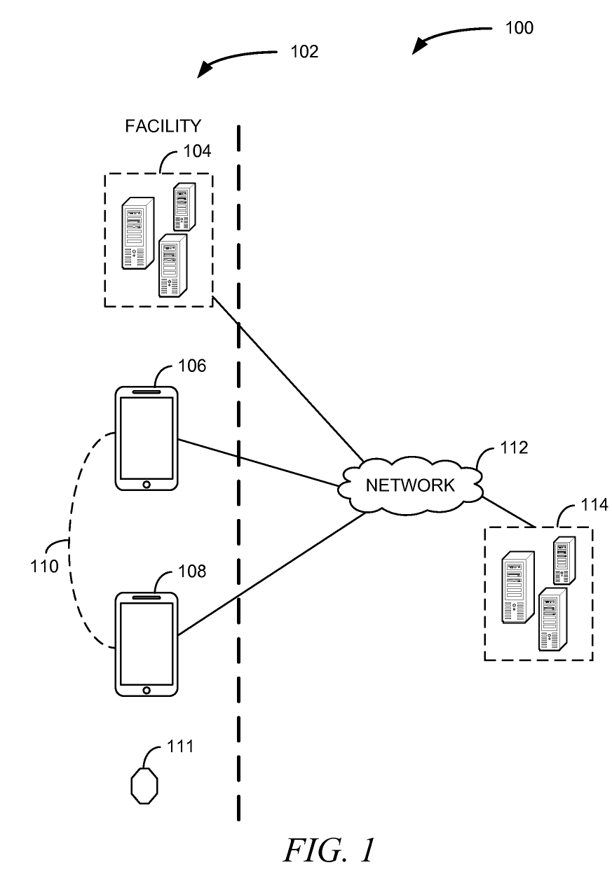

FIG. 1 is a logical block diagram of a system 100, according to an example embodiment. The system 100 is a simplified illustration that includes two mobile devices 106, 108 and a beacon device 111 located within a facility 102. The facility 120 also includes a computing system 104, such as a transaction processing system or store management system that may include transaction processing, inventory, ordering, customer account management, and other functionality. Each of the mobile devices 106, 108 and the computing system 104 connect to a network 112, such as the Internet. Also connected to the Internet is a backend system 114. The backend system 114 is a generalized representation of a computing system that maintains customer account data and may perform other functions with regard to the facility 102, other facilities, beacon device deployment functionality and configuration, and the like.

The mobile devices 106, 108 may individually be one of a smartphone, a smartwatch, wearable device, a tablet, a laptop computer, and other such computing devices that include a transceiver device, such as a BLUETOOTH® transceiver. Each of the mobile devices 106, 108 typically includes an app that executes thereon, which may include an app provided by a facility 102 operator. However, some or all of the mobile device functionality may also or alternatively be a part of operating software of one or more device types, such as an operating system and other platform layer software (i.e., BIOS). Thus, when reference is made to a mobile device app herein, this is not intended to limit the scope of the disclosure but should be considered more broadly.

In some embodiments, presence of the mobile device 106 at the facility 102 is detected. For example, a GPS sensor of the mobile device 106 may identify a position of the mobile device 106 registered in the backend system 114 or computing system 104 in association with the facility 102, location input may be received by the mobile device 106, a signal may be received from a wireless access point or a beacon device including an identifier registered in the backend system 114 or computing system 104 in association with the facility 102, and the like. An app on the mobile device 106 may then transmit data to the backend system 114 including the location data. The mobile device 106 may also transmit data to the backend system that associates the mobile device 106 or the mobile device app session with a customer account maintained in the backend system 114.

In these and some other embodiments, a mobile device app of one customer may also operate passively as a beacon device. For example, when a location of the mobile device 108 is known in the backend system 114, the mobile device 106 app may receive a radio signal 110 from the mobile device 108, which may then be utilized to identify a location of the mobile device 106. Thus, in some embodiments, mobile device apps of both mobile devices 106, 108 may execute in the background to report identifiers included in received radio signals. Accordingly, the mobile device 106 location may be determined in the backend system 114 based on receipt of beacon device 111 signals, GPS location from a GPS device of the mobile device, Wireless Access Point (WAP) signals, or even user input that is transmitted to the backend system. The received radio signals may be transmitted by other mobile devices, such as by a BLUETOOTH® transceiver of the mobile device 108 while the BLUETOOTH® functionality is turned on. These broadcast signals typically include an identifier that is unique to the transceiver device, such as a MAC address. When the MAC address is associated with a customer account stored in the backend system, the mobile device 106 simply relaying received MAC addresses, and optionally a varying signal strength of the received signal including the MAC address, the backend system 114 is then aware of the approximate location of the customer of the customer account associated with the MAC address. Thus, mobile devices 106, 108 may be enabled to passively capture and relay data of received signals 110 to assist in a successful beacon device deployment.

In some embodiments, a beacon device 111 may be deployed at or near an entrance to the facility 102. This deployment of a beacon device 111 near an entrance to a facility may enable such embodiments to quickly identify the presence of a customer via their carried mobile device 106 and equally, their departure. Some embodiments may also include additional beacon devices 111 deployed elsewhere at or near the facility.

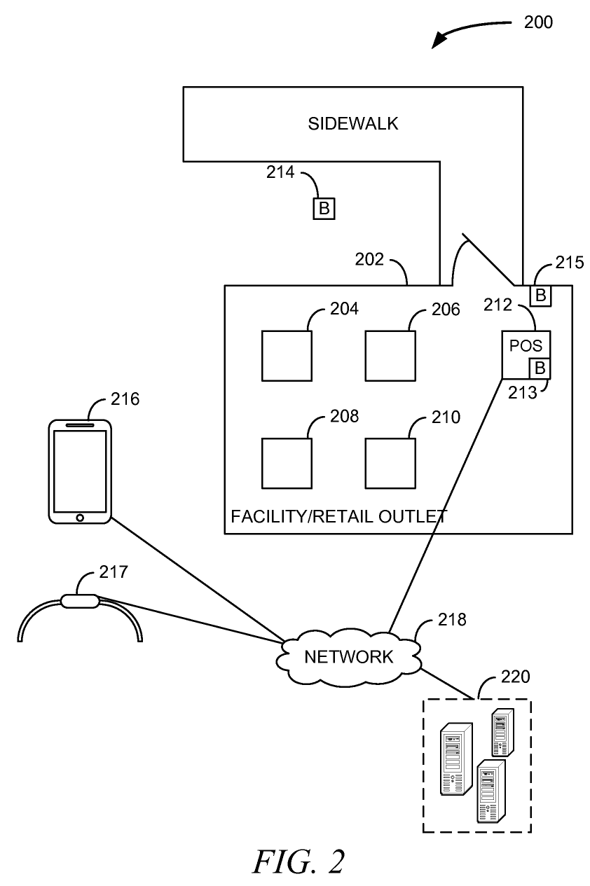

FIG. 2 is a logical block diagram of a system 200, according to an example embodiment. The system 200 is illustrated as deployed with regard to a facility 202, such as a retail outlet, although other embodiments may be deployed to other facility types, such as restaurants, concession stands, casinos, hospitals, and other facility types.

In an example embodiment, a customer carrying a mobile device 216, 217, such as a smartphone, smartwatch, wearable device, or tablet, may enter the facility 202. The customer mobile device 216, 217 typically includes a mobile device app that executes thereon that allows the customer to perform various actions, such as one or more of creating an account, adding and modifying payment account information, viewing and selecting items offered for sale at the facility 202, and to create an order therefore. Some embodiments of the mobile device 216, 217 app may perform additional actions. The additional actions may include viewing receipts of visits, interactions in the facility 202 or other facilities or access points (e.g., websites, kiosks, etc.), completing surveys, viewing a current bill, viewing a facility 202 map, viewing data of appointments and reservations, checking in at the facility with regard to an appointment or reservation, making a payment, and the like. The mobile device 216, 217 app, in some embodiments, receives data received by a transceiver device present on the mobile device 216, 217, such as one or both of a BLUETOOTH® device and a WI-FI® device. In some embodiments, data may also be received via a GPS device of the mobile device 216, 217. An example of data that may be received by the mobile device 216, 217 app is data from one or more beacon devices 213, 214, 215 deployed in and around the facility 202. The data from the one or more beacon devices 213, 214, 215 typically includes identifiers of the respective beacon devices. These beacon device identifiers enable the mobile device 216, 217 app or a backend system 220 service to determine a location of the mobile device. A beacon device identifier included in data transmitted from a mobile device 216, 217 may also trigger performance of one or more data processing activities configured in the backend system 220 with regard to a particular beacon device 213, 214, 215. The mobile device 216, 217, and the app thereon, may receive data from one of the beacon devices 213, 214, 215 or a plurality of beacon devices 213, 214, 215.

In some embodiments, a mobile device 216, 217 for which a location is known to the backend system 220, may operate as a beacon device for other mobile devices 216, 217. For example, a transceiver device of a mobile device 216, 217, such as a BLUETOOTH® transceiver, periodically broadcasts radio signals when the transceiver is enabled. These signals may be transmitted to determine what other devices may be present and available for connection. These signals typically include a unique identifier encoded therein, such as a MAC address of the transceiver. In some embodiments, a mobile device 216, 217 may receive such a signal and transmit the identifier and an account identifier of the user of the mobile device 216, 217 to the backend system 220 via network 218. A backend system 220 process may then query maintained customer account data that includes such identifiers stored in with or in association with customer accounts. This query is performed based on the identifier to determine if a location is known with regard to a mobile device of that identifier. When a location is known with regard to the identifier, a location of the mobile device 216, 217 from which the data was received is known to the backend system 220. The backend system 220 may then perform additional functions that may be triggered with regard to that location with regard to the particular customer account of the account identifier. Conversely, a mobile device 216, 217 may receive such a signal including a unique identifier from another mobile device 216, 217. The receiving mobile device 216, 217 may then relay the identifier to the backend system 220 and similar processing may occur. Such embodiments may enable locating of a mobile device 216, 217 located where beacon devices 213, 214, 216 are out of range.

In one embodiment, a customer carrying a mobile device 216, 217 arrives at the facility 202. The mobile device 216, 217 may receive a signal from one or both of beacon devices 214, 215 located immediately outside or immediately inside 215 the facility 202. An app on the mobile device 216, 217 may then transmit a received beacon device 214, 215 identifier and a unique identifier associated with a customer account, such as an account number, user name, wireless device MAC address, and the like, to the backend system 220. The backend system then associates the customer's presence with the facility in stored data. In some embodiments, a message may then be transmitted to the customer for presentation within the mobile device 216, 217 app, to a phone number (e.g., text message) or email address associated with the customer account, or otherwise with information such as to welcome the customer to the facility, provide access to customer assistance, provide a store map, provide coupons or other promotional content, and the like.

In further embodiments, additional beacon devices may be deployed in various locations in the facility, such as at one or more of locations 204, 206, 208, 210. These locations 204, 206, 208, 210 may be locations of certain products, kiosks, informational displays, departments, and the like. As a customer's presence is detected at or near one of these locations 204, 206, 208, 210, the location may be recorded in the backend system 220 with regard to the customer's visit to the facility 202. Additionally, some embodiments may include the backend system 220 sending a message to the customer in a similar manner as described above to provide additional information about the product or products located at the particular location 204, 206, 208, 210, which may include product information, pricing information, promotional information, coupons, and the like.

Eventually the customer may reach a Point-of-Sale (POS) terminal 212 to complete a purchase transaction. The customer's presence at the POS terminal 212 may be identified through radio signal from a beacon device 213 there located, by the customer providing customer account information, or by other means as described herein. The customer's presence at the POS terminal 212 will be recorded in the backend system 220 with regard to the customer's facility 202 visit. In some embodiments, a record of the items purchased may also be recorded in association with one or both of the customer's account and the facility 202 visit.

The customer, whether completing a transaction at the POS terminal 212 or not, eventually leaves the facility 202. The customer departure may be determined similar to detecting the arrival at the facility. That is, the customer's mobile device 216, 217 may receive a signal from one or both of beacon devices 214, 215 located immediately outside or immediately inside 215 the facility 202. The app on the mobile device 216, 217 may then transmit a received beacon device 214, 215 identifier and the unique identifier associated with a customer account to the backend system 220. The backend system then associates the customer's departure with the facility in stored data. In some embodiments, a message may then be transmitted to the customer for presentation within the mobile device 216, 217 app, to a phone number (e.g., text message) or email address associated with the customer account, or otherwise. The message may include various elements of information such as to thank the customer for visiting the facility, provide access to customer assistance, provide coupons or other promotional content for future visits, provide a survey, and the like. Some embodiments may tailor this information based on one or more factors. These factors may include the specific customer, whether a transaction was completed to purchase products or services, provide a survey where the content of the survey is tailored based on whether purchases were made and facility 202 areas 204, 206, 208, 210 visited, among other tailoring that may be made depending on the particular embodiment.

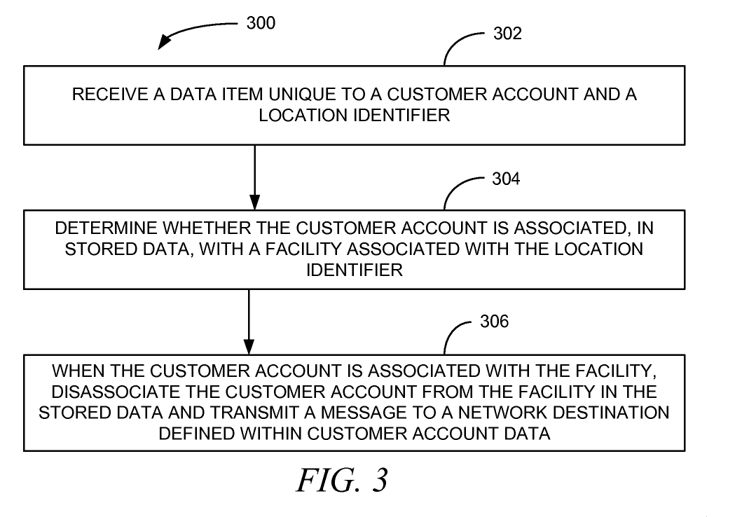

FIG. 3 is a logical block diagram of a method 300, according to an example embodiment. The method 300 is an example of a method performed in whole or in part on a backend system, such as backend system 114 of FIG. 1 and backend system 220 of FIG. 2.

The method 300 includes receiving 302 a data item unique to a customer account and a location identifier. The data item unique to the customer account may include or more data items in various embodiments. The one or more data items may include one or more of a customer account identifier, a user name, a password, a MAC address of a wireless transceiver device of a customer mobile device, a globally unique identifier (GUID) of a customer mobile device or hardware or software element present thereon, among other possible unique identifiers.

The method 300 further includes determining 304 whether the customer account is associated, in stored data, with a facility associated with the location identifier. This is determination 304 of whether a customer's presence at a facility is already known. When the customer's presence is not already known, some embodiments of the method 300 include associating the customer account with the facility in the stored data indicating the mobile device associated with the customer account is present at the facility. However, when the customer's presence is already known at the facility, the method 300 includes disassociating 306 the customer account from the facility in the stored data and transmitting a message to a network destination defined within customer account data. The network destination may be a customer email address, a phone number to which text messages may be sent, an indication to send the message to a mobile device app, and the like.

In some embodiments of the method 300, transmitting the message includes retrieving data, such as from a database of a backend or other system, based at least an identifier of the customer account. The retrieved data may include one or more of a transaction summary of transaction activity performed while present at the facility, a survey, a link to a survey, and a retrieved customer account balance, such as a loyalty point balance, a store credit balance, a credit card balance, and the like. The retrieved data may also include, such as a part of the transaction summary of transaction activity performed while present at the facility, a listing of visited facility areas, such as departments, aisles, kiosks, and the like. This may also include a listing of an amount of time spent in each. Transmitting the message in such embodiments further includes generating the message to be transmitted to include a representation of the retrieved data.

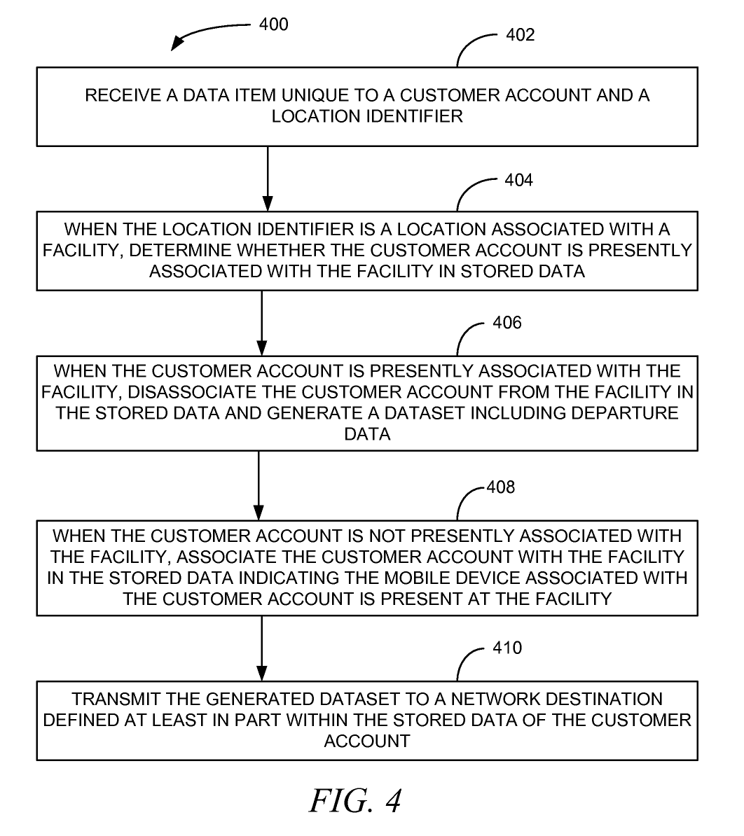

FIG. 4 is a logical block diagram of a method 400, according to an example embodiment. The method 400 is another example of a method performed in whole or in part on a backend system, such as backend system 114 of FIG. 1 and backend system 220 of FIG. 2.

The method 400 includes receiving 402 a data item unique to a customer account and a location identifier. The data item unique to the customer account may include or more data items in various embodiments. The one or more data items may include one or more of a customer account identifier, a user name, a password, a MAC address of a wireless transceiver device (e.g., a WI-FI® or BLUETOOTH® transceiver) of a customer mobile device, a globally unique identifier (GUID) of a customer mobile device or hardware or software element present thereon, among other possible unique identifiers.

When the location identifier is a location associated with a facility, the method 400 include determining 404 whether the customer account is presently associated with the facility in stored data. When the customer account is presently associated with the facility, the method 400 disassociates 406 the customer account from the facility in the stored data and generating a dataset including departure data. However, when the customer account is not presently associated with the facility, the method 400 associates 408 the customer account with the facility in the stored data indicating the mobile device associated with the customer account is present at the facility. The method 400 then transmits 410 the generated dataset to a network destination defined at least in part within the stored data of the customer account.

In some embodiments, when the customer account is not presently associated with the facility, the method 400 further includes generating a dataset including welcome data. Generating the dataset including welcome data, according to some embodiments, includes retrieving welcome data based on at least one of an identifier of the facility, an identifier of the customer account, a current date, a current time, and at least one data item of the customer account. The retrieved welcome data may include one or more of promotional data retrieved with regard to the facility, a retrieved customer account balance, a coupon, a welcome message, a facility map, and other data.

In some embodiments of the method 400, generating the dataset including the departure data includes retrieving departure data. The departure data may be retrieved based on at least one of an identifier of the facility, an identifier of the customer account, a current date, a current time, customer account activity performed while present at the facility, at least one data item of the customer account, and other data. In some embodiments, the departure data includes at least one of a thank you message, a transaction summary of transaction activity performed while present at the facility, and a general or a tailored survey, or a link thereto, tailored based on data associated with the customer account. The departure data may also, or alternatively, include a link or user interface control that is selectable to connect via telephone or video conference from the customer's mobile device with a facility employee that may be located at the facility or elsewhere. The departure data may also include one or more of promotional data retrieved with regard to the facility, a retrieved customer account balance, and a coupon.

In some embodiments, the method 400 further includes storing customer account data in a database. The data of each customer account generally includes a customer account identifier, an address of the network destination to which messages regarding the customer account are to be transmitted 410, and a record of completed transactions. The data of each customer account may further include a unique identifier of a wireless transceiver device of a mobile device. In some such embodiments, associating 408 the customer account with the facility in the stored data includes writing a data record including the customer account identifier to a dataset associated with the facility. This may further include writing a first time element representative of at least one of a date and time of the associating. Further, disassociating 406 the customer account from the facility in the stored data may include writing to the data record of the respective customer account identifier, a second time element representative of at least one of a date and time of the disassociating.

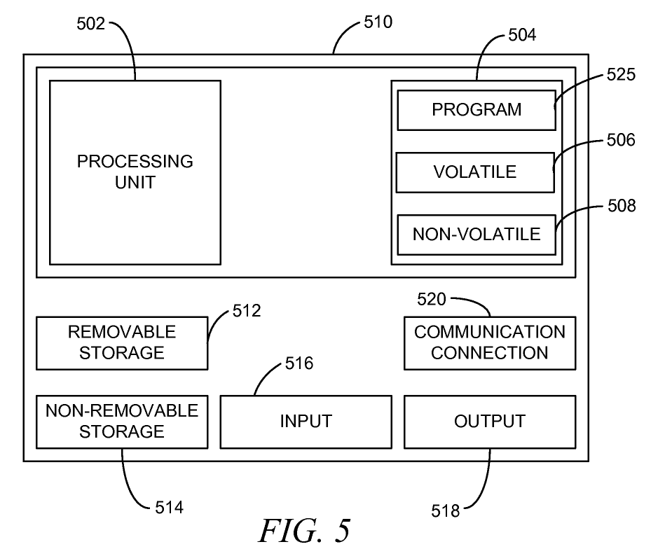

FIG. 5 is a block diagram of a computing device, according to an example embodiment. In one embodiment, multiple such computer systems are utilized in a distributed network to implement multiple components in a transaction-based environment. An object-oriented, service-oriented, or other architecture may be used to implement such functions and communicate between the multiple systems and components. One example computing device in the form of a computer 510, may include a processing unit 502, memory 504, removable storage 512, and non-removable storage 514. Although the example computing device is illustrated and described as computer 510, the computing device may be in different forms in different embodiments. For example, the computing device may instead be a smartphone, a tablet, smartwatch, wearable device, or other computing device including the same or similar elements as illustrated and described with regard to FIG. 5. Devices such as smartphones, tablets, wearable devices, and smartwatches are generally collectively referred to as mobile devices. Further, although the various data storage elements are illustrated as part of the computer 510, the storage may also or alternatively include cloud-based storage accessible via a network, such as the Internet.

Returning to the computer 510, memory 504 may include volatile memory 506 and non-volatile memory 508. Computer 510 may include—or have access to a computing environment that includes a variety of computer-readable media, such as volatile memory 506 and non-volatile memory 508, removable storage 512 and non-removable storage 514. Computer storage includes random access memory (RAM), read only memory (ROM), erasable programmable read-only memory (EPROM) and electrically erasable programmable read-only memory (EEPROM), flash memory or other memory technologies, compact disc read-only memory (CD ROM), Digital Versatile Disks (DVD) or other optical disk storage, magnetic cassettes, magnetic tape, magnetic disk storage or other magnetic storage devices, or any other medium capable of storing computer-readable instructions.

Computer 510 may include or have access to a computing environment that includes input 516, output 518, and a communication connection 520. The input 516 may include one or more of a touchscreen, touchpad, mouse, keyboard, camera, one or more device-specific buttons, one or more sensors integrated within or coupled via wired or wireless data connections to the computer 510, and other input devices. The computer 510 may operate in a networked environment using a communication connection 520 to connect to one or more remote computers, such as database servers, web servers, and other computing device. An example remote computer may include a personal computer (PC), server, router, network PC, a peer device or other common network node, or the like. The communication connection 520 may be a network interface device such as one or both of an Ethernet card and a wireless card or circuit that may be connected to a network. The network may include one or more of a Local Area Network (LAN), a Wide Area Network (WAN), the Internet, and other networks. In some embodiments, the communication connection 520 may also or alternatively include a transceiver device, such as a BLUETOOTH® device that enables the computer 510 to wirelessly receive data from and transmit data to other BLUETOOTH® devices.

Computer-readable instructions stored on a computer-readable medium are executable by the processing unit 502 of the computer 510. A hard drive (magnetic disk or solid state), CD-ROM, and RAM are some examples of articles including a non-transitory computer-readable medium. For example, various computer programs 525 or apps, such as one or more applications and modules implementing one or more of the methods illustrated and described herein or an app or application that executes on a mobile device or is accessible via a web browser, may be stored on a non-transitory computer-readable medium.

It will be readily understood to those skilled in the art that various other changes in the details, material, and arrangements of the parts and method stages which have been described and illustrated in order to explain the nature of the inventive subject matter may be made without departing from the principles and scope of the inventive subject matter as expressed in the subjoined claims.

1. A method comprising:
receiving a data item unique to a customer account and a location identifier;
when the location identifier is a location associated with a facility entrance and exit area, determining whether the customer account is presently associated with the facility in stored data;
when the customer account is presently associated with the facility, disassociating the customer account from the facility in the stored data and generating a dataset including departure data;
when the customer account is not presently associated with the facility, associating the customer account with the facility in the stored data indicating the mobile device associated with the customer account is present at the facility;
transmitting the generated dataset to a network destination defined at least in part within the stored data of the customer account; and
when the customer account is presently associated with the facility:
receiving a location identifier associated with a particular product and the data item unique to the customer account thereby indicating the customer is viewing the particular product; and
retrieving and transmitting data with regard to the particular product to the mobile device associated with the customer account.

2. The method of claim 1, wherein:
the network destination defined at least in part within the stored data of the customer account includes an address of the mobile device to which a message can be sent; and
the transmitting includes transmitting a message to the mobile device based on the generated dataset.

3. The method of claim 1, wherein when the customer account is not presently associated with the facility, the method further includes generating a dataset including welcome data.

4. The method of claim 3, wherein:
generating the dataset including welcome data includes:
retrieving welcome data based on at least one of an identifier of the facility, an identifier of the customer account, a current date, a current time, and at least one data item of the customer account; and
the welcome data includes at least one of:
promotional data retrieved with regard to the facility;
a retrieved customer account balance;
a coupon;
a welcome message;
a link to connect with a facility employee; and
a facility map.

5. The method of claim 1, wherein:
generating the dataset including the departure data includes:
retrieving departure data based on at least one of an identifier of the facility, an identifier of the customer account, a current date, a current time, customer account activity performed while present at the facility, and at least one data item of the customer account; and
the departure data includes at least one of:
a thank you message;
a transaction summary of transaction activity performed while present at the facility;
a survey;
a link to a survey;
a link to connect with a facility employee;
promotional data retrieved with regard to the facility;
a retrieved customer account balance; and
a coupon.

6. The method of claim 1, wherein the location identifier is an identifier of a wireless transceiver device deployed at the facility and registered in configuration data of a system performing the method in association with an entrance to the facility.

7. The method of claim 6, wherein the wireless transceiver device is a beacon device.

8. The method of claim 7, wherein receiving the data item unique to the customer account and the location identifier includes receiving a customer account identifier and the identifier of the beacon device via a network from the mobile device.

9. The method of claim 7, wherein receiving the data item unique to the customer account and the location identifier includes receiving, from the beacon device, a wireless device identifier of the mobile device, the wireless device identifier stored in association with the customer account.

10. The method of claim 1, further comprising:
storing customer account data in a database, the data of each customer account including:
a customer account identifier;
an address of the network destination to which messages regarding the customer account are to be transmitted; and
a record of completed transactions.

11. The method of claim 10, wherein the data of each customer account further includes a unique identifier of a wireless transceiver device of a mobile device.

12. The method of claim 10, wherein:
associating the customer account with the facility in the stored data includes writing a data record including the customer account identifier to a dataset associated with the facility and a first time element representative of at least one of a date and time of the associating; and
disassociating the customer account from the facility in the stored data includes writing to the data record of the respective customer account identifier, a second time element representative of at least one of a date and time of the disassociating.

13. A method comprising:
receiving a data item unique to a customer account and a location identifier;
determining whether the customer account is associated, in stored data, with a associated with the location identifier;
when the location identifier is associated with an exit of the facility and the customer account is associated with the facility, disassociating the customer account from the facility in the stored data and transmitting a message to a network destination defined within customer account data;
when the location identifier is associated with an entrance of the facility and the customer account is not associated with the facility, associating the customer account with the facility in the stored data indicating the mobile device associated with the customer account is present at the facility; and
when the customer account is presently associated with the facility;
receiving a location identifier associated with a particular product and the data item unique to the customer account thereby indicating the customer is viewing the particular product; and
retrieving and transmitting data with regard to the particular product to the mobile device associated with the customer account.

14. (canceled)

15. The method of claim 13, wherein transmitting the message includes:
retrieving data based at least an identifier of the customer account, the retrieved data including at least one of:
a transaction summary of transaction activity performed while present at the facility;
a survey;
a link to a survey;
a link to connect with a facility employee; and
a retrieved customer account balance; and
generating the message to be transmitted to include a representation of the retrieved data.

16. The method of claim 13, wherein the location identifier is an identifier of a wireless transceiver device deployed at the facility and registered in configuration data of a system performing the method in association with an entrance to the facility.

17. A system comprising:
at least one network interface device, at least one processor, and at east one memory device, the at least one memory device storing instructions executable by the at least one processor to perform data processing activities, the data processing activities comprising:
receiving, via the at least one network interface device, a data item unique to a customer account and a location identifier;
determining whether the customer account is associated, in stored data, with a facility associated with the location identifier;
when the location identifier is associated with an exit of the facility and the customer account is associated with the facility, disassociating the customer account from the facility in the stored data and transmitting, via the at least one network interface device, a message to a network destination defined within customer account data;
when the location identifier is associated with an entrance of the facility and the customer account is not associated with the facility, associating the customer account with the facility in the stored data indicating the mobile device associated with the customer account is present at the facility; and
when the customer account is presently associated with the facility:
receiving a location identifier associated with a particular product and the data item unique to the customer account thereby indicating the customer is viewing the particular product; and
retrieving and transmitting data with regard to the particular product to the mobile device associated with the customer account.

18. (canceled)

19. The method of claim 17, wherein transmitting the message includes:
retrieving data based at least an identifier of the customer account, the retrieved data including at least one of:
a transaction summary of transaction activity performed while present at the facility;
a survey;
a link to a survey;
a link to connect with a facility employee; and
a retrieved customer account balance; and
generating the message to be transmitted to include a representation of the retrieved data.

20. The method of claim 17, wherein the location identifier is an identifier of a wireless transceiver device deployed at the facility and registered in configuration data of the system in association with an entrance to the facility.
